(19) United States
(12) Patent Application Publication
(10) Pub. No.: US 2007/0109395 A1
(43) Pub. Date: May 17, 2007

(54) Led array head and image recording device

(75) Inventors: Yoichi Watanabe, Kanagawa (JP); Yoshio Suzuki, Kanagawa (JP); Eitoku Sonoda, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/447,979

(22) Filed: Jun. 7, 2006

(30) Foreign Application Priority Data
Nov. 15, 2005 (JP) 2005-330305

(51) Int. Cl. B41J 2/45

(52) U.S. Cl. 347/238

(57) ABSTRACT

An LED array head has LED arrays, a substrate, first electrode pads, second electrode pads, and light-blocking elements. Plural LEDs are positioned at the LED arrays. The LED arrays are staggered on the substrate. The first electrode pads are provided at end portions of the LED arrays and positioned facing LEDs of adjacent LED arrays. The second electrode pads are provided on the substrate at a side opposite the adjacent LED arrays and connected to the first electrode pad electrically by the wires. The light-blocking elements block light, which is emitted from the LEDs of the adjacent LED arrays, from reaching the wires.

### CROSS-REFERENCE TO RELATED APPLICATION

This application claims priority under 35 USC 119 from Japanese Patent Application No. 2005-330305, the disclosure of which is incorporated by reference herein.

### BACKGROUND

1. Technical Field

The present invention relates to an LED array head having plural LEDs, and to an image recording device.

2. Related Art

Conventionally, an LED array, which is used in an LED array head or the like as a light-emitting device, and a printed board are connected by bonding wires. At the portions where the bonding wires are joined on the LED array, the light from the light-emitting points of the LEDs is reflected by the balls or the wires or the like of the bonding wires, and it is easy for scattered light and stray light to arise.

Because photoreceptors are exposed by this scattered light or stray light at exposure amounts which are greater than or equal to their original exposure amounts, a problem arises in that image stripes are formed and the image quality deteriorates.

### SUMMARY

In consideration of the above circumstances, the present invention provides an LED array head and an image recording device.

A first aspect of the present invention is an LED array head including: LED arrays at which plural LEDs are positioned; a substrate on which the LED arrays are staggered; first electrode pads provided at end portions of the LED arrays and positioned facing LEDs of adjacent LED arrays; second electrode pads provided on the substrate at a side opposite the adjacent LED arrays and connected to the first electrode pads electrically by wires; and light-blocking elements that block light, which is emitted from the LEDs of the adjacent LED arrays, from reaching the wires.

### BRIEF DESCRIPTION OF THE DRAWINGS

Embodiments of the present invention will be described in detail based on the following figures, wherein:

FIG. 1 is a schematic structural diagram showing the structure of an image recording device to which an LED array head relating to an exemplary embodiment of the present invention is applied;

FIG. 2 is a perspective view explaining the relationship between a photoreceptor and the LED array head relating to the exemplary embodiment of the present invention;

FIG. 3 is a plan view showing the LED array head relating to the exemplary embodiment of the present invention;

FIG. 4 is a cross-sectional view showing a state in which a bonding wire of an LED array relating to the exemplary embodiment of the present invention is covered by a light-blocking insulator;

FIG. 5A is a schematic diagram showing a state in which stray light due to light from light-emitting points of LEDs arises, and FIG. 5B is a schematic diagram corresponding to FIG. 5A and showing results of an example;

FIG. 6 is a cross-sectional view showing a state in which the LED array relating to the exemplary embodiment of the present invention is bonded by BSOB;

FIG. 7A is an explanatory diagram showing a shape of a bonding wire in accordance with standard bonding, FIG. 7B is an explanatory diagram showing a shape of a bonding wire in accordance with BSOB, FIG. 7C is an explanatory diagram showing a shape of a bonding wire in accordance with an ultra-low loop, and FIG. 7D is an explanatory diagram showing a shape of a bonding wire in accordance with STCB;

FIG. 8B is an enlarged plan view showing the LED array head, and FIG. 8A is a side view showing the shapes of respective bonding wires at positions corresponding to FIG. 8B;

FIG. 9 is a cross-sectional view showing an example in which a light-blocking wall is provided between bonding wires of the LED array relating to the exemplary embodiment of the present invention and LEDs of an adjacent LED array;

FIG. 10 is a cross-sectional view showing an example in which the heights of LED arrays relating to the exemplary embodiment of the present invention are changed;

FIG. 11 is a cross-sectional view showing another example in which the heights of LED arrays relating to the exemplary embodiment of the present invention are changed; and

FIG. 12 is a cross-sectional view showing a comparative example of FIG. 4.

### DETAILED DESCRIPTION

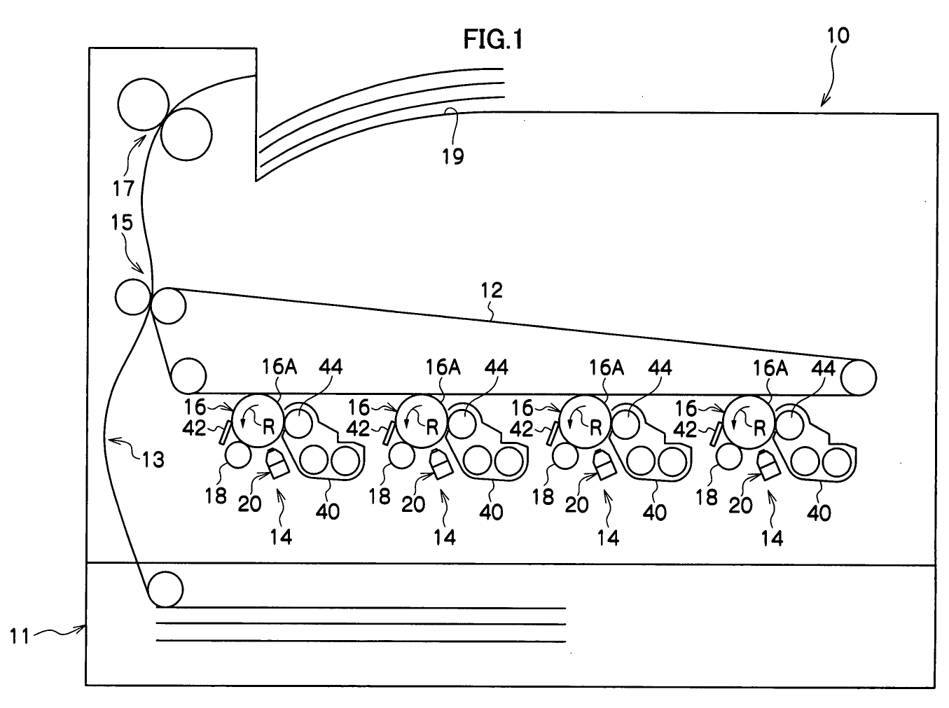

An image recording device 10, to which an LED array head 20 relating to an exemplary embodiment of the present invention is applied, is shown in FIG. 1. The image recording device 10 is a so-called tandem-type image recording device. The image recording device 10 has an intermediate transfer belt 12 which spans substantially horizontally. Four image recording sections 14, which correspond to respectively different developing colors, are disposed beneath the intermediate transfer belt 12.

A sheet tray 11 is provided beneath the image recording sections 14. A conveying path 13, which extends upward from the sheet feeding side of the sheet tray 11, passes through a secondary transfer section 15 which contacts the intermediate transfer belt 12, and a fixing section 17 which has a fixing device, and reaches a discharge opening. The outer side of the discharge opening is a sheet discharge tray 19.

Each of the image recording sections 14 has a photoreceptor 16, a charger 18, an LED array head 20, a developing device 40, and a cleaner 42.

The photoreceptor 16 is shaped as a cylindrical tube, and the outer peripheral surface thereof is a light-receiving surface 16A. An electrostatic latent image can be formed on the light-receiving surface 16A. The light-receiving surface 16A contacts the intermediate transfer belt at the downstream side, in the direction of rotation of the photoreceptor (the direction of arrow R), of the developing device 40 (hereinafter simply called “downstream side”).

The charger 18 is an electrically conductive roller. The core of the charger 18 is formed of metal, and is covered by an elastic layer made of a synthetic resin. Negative-polarity voltage is applied by a power source (not shown). The LED array head 20 is disposed at the downstream side of the charger 18. The LED array head 20 irradiates a light-image onto the light-receiving surface 16A (photosensitive surface) of the photoreceptor 16. In this way, the photoreceptor 16, which is charged by the charger 18, is exposed, and an electrostatic latent image is formed thereon.

The developing device 40 is disposed at the downstream side of the LED array head 20. A two-component developing agent, in which a toner and a carrier are mixed together, is filled in the developing device 40. The toner and the carrier filled in the developing device 40 are stirred, frictionally-charged, and mixed together uniformly. The toner is thereby electrostatically attracted to the carrier.

The carrier, which is a magnetic powder, is attracted by the magnetic force of a magnet roller 44 which is disposed so as to oppose the photoreceptor 16. The toner, which adheres to the carrier on the magnet roller 44, electrostatically adheres to the photoreceptor 16 due to the potential difference (the developing potential) between the potential (—200 V) at which the photoreceptor 16 is exposed and the developing bias potential (—550 V).

In this way, the developing device 40 causes the toner to adhere to and develop the electrostatic latent image formed on the photoreceptor 16, so as to form a toner image. Then, the toner image is transferred onto the intermediate transfer belt 12, and the toner images of all of the colors are ultimately superposed one on top of another on the intermediate transfer belt 12.

On the other hand, the cleaner 42, which is disposed at the downstream side of the developing device 40, abuts the light-receiving surface 16A of the photoreceptor 16 and removes adhering matter (waste toner, waste carrier, and the like) which adheres to the photoreceptor 16.

The LED array head relating to the first exemplary embodiment of the present invention will be described.

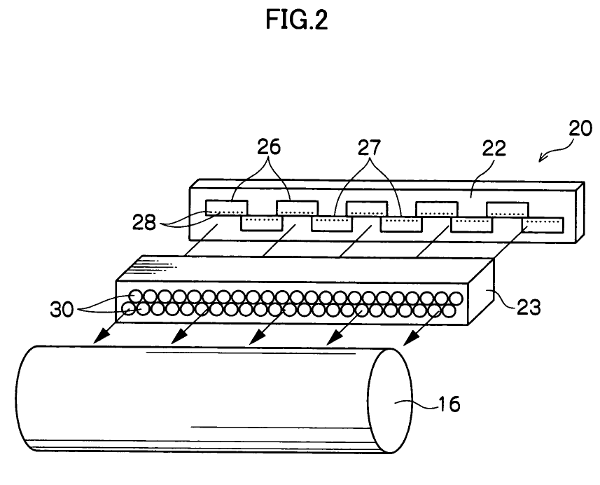

As shown in FIG. 2, the LED array head 20 has an elongated printed board 22. Circuits, which are for supplying various types of signals which control the driving of the LED array head 20 (respective LEDs 28), are formed on the printed board 22. Image data of an amount corresponding to one line can be processed successively.

LED arrays (also called LED chips) 26, 27 are lined-up in a staggered manner, adjacent to one another on the printed board 22 such that longitudinal direction end portions thereof partially overlap one another. The plural LEDs 28, which are lined-up one-dimensionally along the longitudinal direction of the LED arrays 26, 27, are provided on the top surfaces of the LED arrays 26, 27. The LEDs 28 of a number which is the number of pixels (number of dots) corresponding to the resolution are provided.

On the other hand, a lens holder 23 is provided at a position opposing the printed board 22. Rod lens arrays (SLAs) 30 serving as collecting lenses (an optical system) are lined-up along the same direction as the longitudinal direction of the printed board 22. The light from the LEDs 28 of the LED arrays 26, 27 is imaged onto the photoreceptor 16 by the rod lens arrays 30.

Here, in the present exemplary embodiment, self-scanning LED (SLED) arrays are used as the LED arrays 26, 27. An SLED array can selectively make the on/off timing of a switch emit light in accordance with two signal wires. Therefore, the data wire can be used in common, and the wiring can be simplified. The structure disclosed in Japanese Patent Application Laid-Open (JP-A) No. 8-216448, for example, can be used as the SLED array.

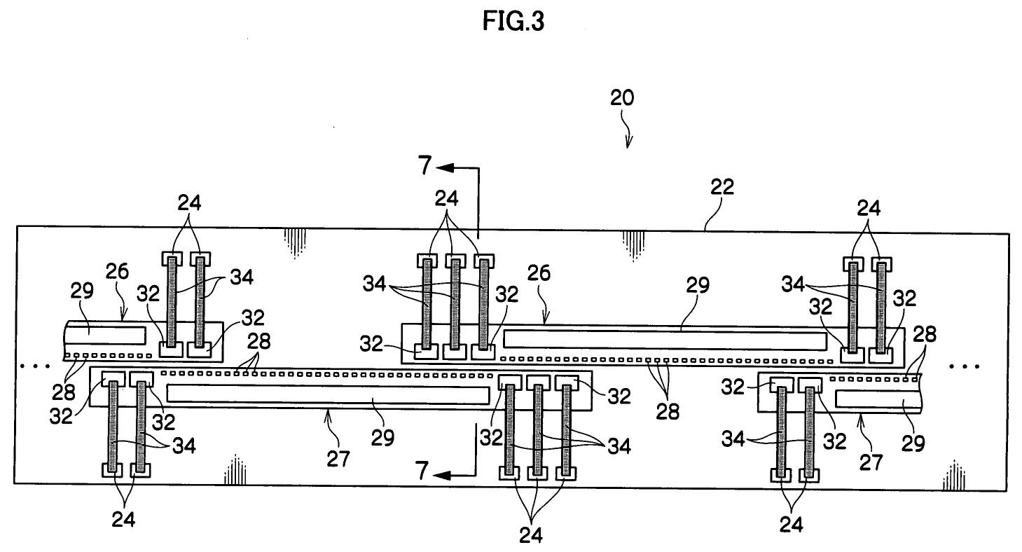

With these self-scanning LEDs, the number of first electrode pads 32 (see FIG. 3), which electrically connect the LED arrays 26, 27 to the printed board 22, can be greatly reduced as compared with a conventional LED array. Therefore, the first electrode pads 32 can be concentrated at the end portions, in the direction in which the LEDs 28 are lined-up, of the LED arrays 26, 27.

Accordingly, as shown in FIG. 3, the first electrode pads 32 are disposed at the longitudinal direction both end sides of the LED arrays 26, 27. Second electrode pads 24 are disposed on the printed board 22 at positions corresponding to the first electrode pads 32. The first electrode pads 32 and the second electrode pads 24 are connected by bonding wires 34 which are formed from metal wires.

By making the number of first electrode pads 32 much smaller than in a conventional LED array, the LED arrays 26, 27 can be made to be more compact. Therefore, the number of chips procured from one wafer can be greatly increased, and the cost per chip can be decreased.

There are no LEDs 28 at the positions where the first electrode pads 32 are disposed. Therefore, in order to carry out exposure without gaps along the axial direction of the photoreceptor 16 (see FIG. 1), the portions where the first electrode pads 32 are disposed at the LED array 27 (or at the LED array 26) are disposed so as to oppose the LEDs 28 of the adjacent LED array 26 (or LED array 27).

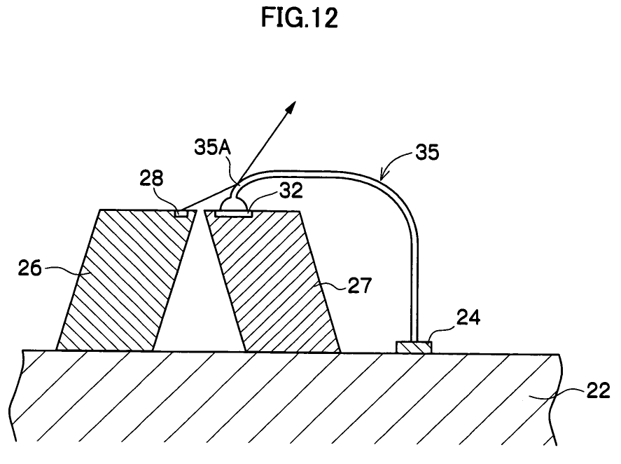

Thus, the first electrode pads 32 of the LED array 27 are disposed at positions in vicinities of the LEDs 28 of the adjacent LED array 26. In the case of FIG. 12, at the portion where a bonding wire 35 is joined to the first electrode pad 32 on the LED array 27, light from the light-emitting points of the LEDs 28 of the LED array 26 is reflected by a wire 35A or the like of the bonding wire 35, and it is easy for scattered light or stray light to arise. (Note that same holds for the LED array 27 with respect to the first electrode pads 32 of the LED array 26, but, for convenience, only the LED array 27 side is explained.)

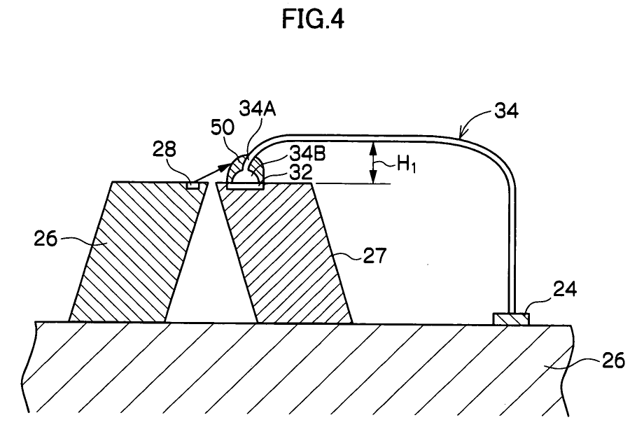

Accordingly, in the present exemplary embodiment, as shown in FIG. 4, a wire 34A and a ball portion 34B at the first electrode pad 32 side of the bonding wire 34 are covered by a light-blocking insulator 50. Here, a silicon or epoxy material is used for the light-blocking insulator 50, and a blackish color which is difficult to reflect the light of the LEDs 28 is used for the light-blocking insulator 50. Further, the light-blocking insulator 50 is made to be matte which is difficult to regularly reflect the light of the LEDs 28.

By covering the wire 34A and the ball portion 34B at the first electrode pad 32 side of the bonding wire 34 with the light-blocking insulator 50, the light from the light-emitting points of the LEDs 28 which are disposed at the adjacent LED array 26 is blocked. Therefore, light is not reflected by the wire 34A at the interior of the light-blocking insulator 50, and the occurrence of scattered light and stray light can be prevented.

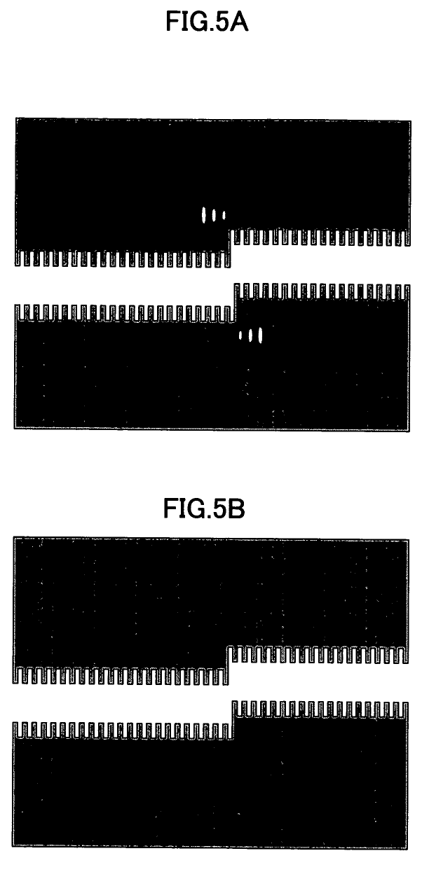

Here, FIGS. 5A and 5B schematically show experimental results, photographed through a CCD, of light which is emitted from the LEDs 28 and passes through the rod lens arrays 30. In the comparative example, as shown in FIG. 5A, stray light (the points shaped like white ovals) arises. In contrast, in the example of the present exemplary embodiment, as shown in FIG. 5B, stray light does not arise.

The generating of stray light can be prevented by covering the first electrode pad 32 side of the bonding wire 34 by the light-blocking insulator 50. Therefore, it suffices to not carry out STCB (so-called stitch bonding which will be described later) at the first electrode pad 32 as a countermeasure to stray light.

Thus, the pad strength (so-called pull strength) of the first electrode pad 32 on the LED array 27 can be lowered, and the size of the first electrode pad 32 can be made smaller. Moreover, because stray light does not arise even though the first electrode pad 32 is small, the LED arrays 26, 27 which are compact can be manufactured, and it is possible to make the image recording device 10 compact.

Concretely, the dimension, in the shorter-side direction, of the LED arrays 26, 27 can be made to be less than or equal to 130 μm. (The size is generally 300 μm.)

Further, the first run rate of production is improved because it suffices to not carry out stitch bonding on the first electrode pad 32 as a countermeasure to stray light. Namely, because the force of bonding to the first electrode pad 32 can be made to be small, there is less damage such as cracking and the like to the LED arrays 26, 27, and an improvement in the yield of the manufactured product can be anticipated.

Here, the wire 34A and the ball portion 34B at the first electrode pad 32 side of the bonding wire 34 are covered by the light-blocking insulator 50, such that the light from the light-emitting points of the LEDs 28 disposed at the adjacent LED array 26 is blocked. However, the present invention is not limited to the same because it suffices to be able to prevent stray light.

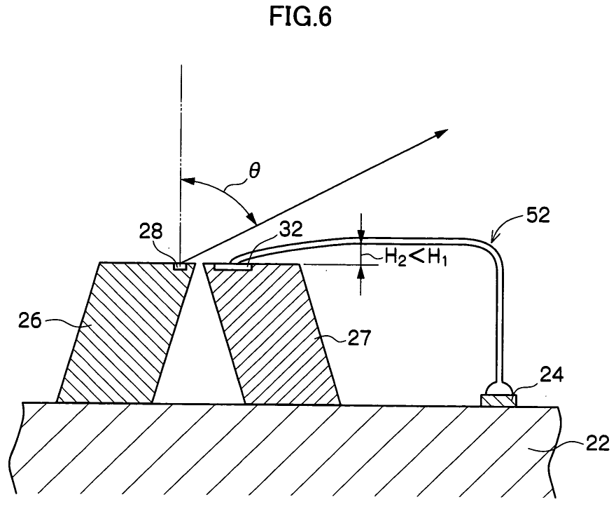

For example, as shown in FIG. 6, the following may be carried out. After producing a ball on the first electrode pad 32, a bonding wire 52 is bonded to the second electrode pad 24 (first bonding), and bonding onto the ball on the first electrode pad 32 is carried out (second bonding). In this way, the ball on the first electrode pad 32 is crushed (so-called BSOB (Bond Stitch on Ball)). The first electrode pad 32 and the second electrode pad 24 are thereby connected electrically. Namely, no ball portion is formed on the first electrode pad 32, and the bonding wire 52 is connected by a low loop.

In this way, the light from the light-emitting points of the LEDs 28 can be made to not reach the bonding wire 52, by connecting the bonding wire 52 by a low loop (H₂<H₁) and making the height of the bonding wire 52 be outside of the light-emitting region of the LEDs 28 disposed at the adjacent LED array 26 (the region shown by the so-called directional angle θ (the spread angle of the light with respect to the optical axis of the LED)). Note that, other than BSOB, an FJ loop (a bonding method by Kaijo Corporation) which is a so-called ultra-low loop also can be applied.

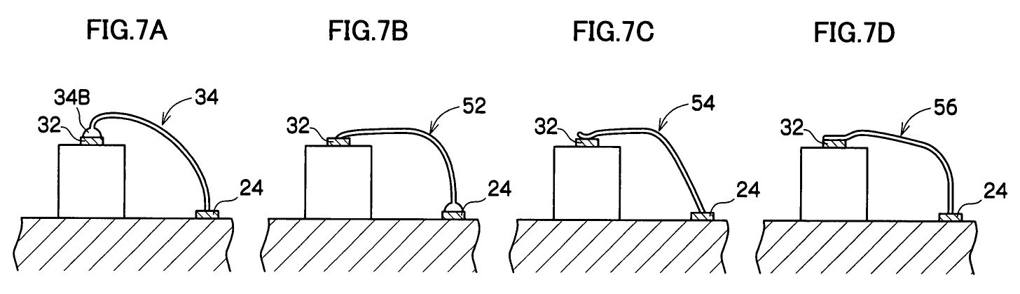

The bonding wire 34 in accordance with standard bonding is shown in FIG. 7A, the bonding wire 52 in accordance with BSOB is shown in FIG. 7B, a bonding wire 54 in accordance with an ultra-low loop is shown in FIG. 7C, and a bonding wire 56 in accordance with STCB (stitch bonding) is shown in FIG. 7D.

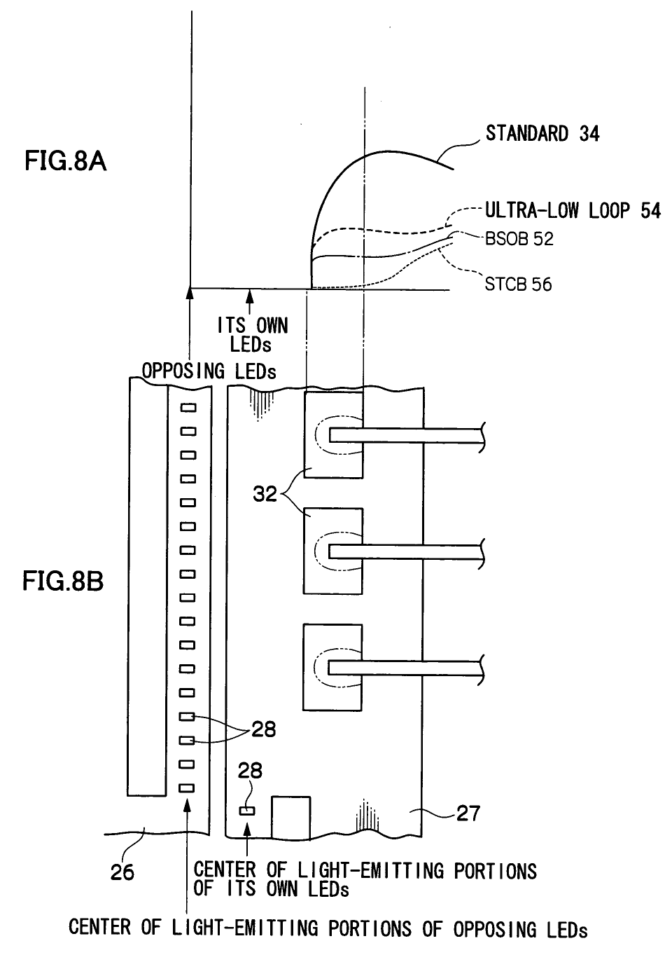

FIG. 8B is an enlarged diagram of the LED arrays 26, 27. A side view of bonding wires connected to the LED array 26 is shown in FIG. 8A. The bonding wire 34 by standard bonding is shown by the solid line, the bonding wire 52 by BSOB is shown by the one-dot chain line, the bonding wire 54 by an ultra-low loop is shown by the dotted line, and the bonding wire 56 by STCB is shown by the fine dotted line. As can be understood from this figure, the loop heights becomes lower in the order of standard bonding, ultra-low loop, BSOB, and STCB.

Here, with standard bonding (see FIG. 7A), if an attempt is made to lower the loop height, problems arise in that the neck (the base) of the ball portion 34B is damaged and becomes easy to break, and the like. Therefore, the bonding specifications must be changed. Further, when the loop height is lowered, the bonding diameter of the ball portion 34B must be made to be small, or the thickness of the ball portion 34B must be made to be thin, and problems arise in terms of strength.

Therefore, a method which does not form the ball portion 34B is desirably used at the first electrode pad 32 side. Accordingly, BSOB (see FIG. 7B), an ultra-low loop (see FIG. 7C), and STCB (see FIG. 7D) are suitable.

With BSOB, the loop can be made sufficiently low, and the pull strength can be ensured sufficiently. Further, an FJ loop eliminates the concern with regard to neck strength. The loop height of an FJ loop is slightly higher than that with BSOB. However, with an FJ loop, the electrode pad can be made even smaller than with BSOB, without changing the bonding specifications.

On the other hand, with STCB, the loop height of the bonding wire 56 is the lowest, and the problem of stray light does not arise. However, because STCB requires a large pad surface area, the widths of the LED arrays 26, 27 become large. Therefore, in a case in which the widths of the LED arrays 26, 27 are only about 125 μm, the pad surface area is small, and there is the concern that the pad may break at the time of bonding.

Accordingly, by not carrying out STCB at the first electrode pads 32 as a countermeasure to stray light, the pad strength of the first electrode pads 32 on the LED arrays 26, 27 can be made to be low, and the size of the first electrode pads 32 can be made to be small.

Namely, by using BSOB or an ultra-low loop as the method of bonding for electrically connecting the first electrode pads 32 and the second electrode pads 24, stray light from the light-emitting points of the LEDs 28 disposed at the adjacent LED array 26 can be prevented, and the LED arrays 26, 27 which are compact can be manufactured.

Further, BSOB or an ultra-low loop may be used as the method of bonding for electrically connecting the first electrode pads 32 and the second electrode pads 24, and further, the connected first electrode pad 32 sides at the bonding wires 52 or the bonding wires 54 may be covered by the light-blocking insulators 50.

An LED array head relating to a second exemplary embodiment of the present invention will be described next.

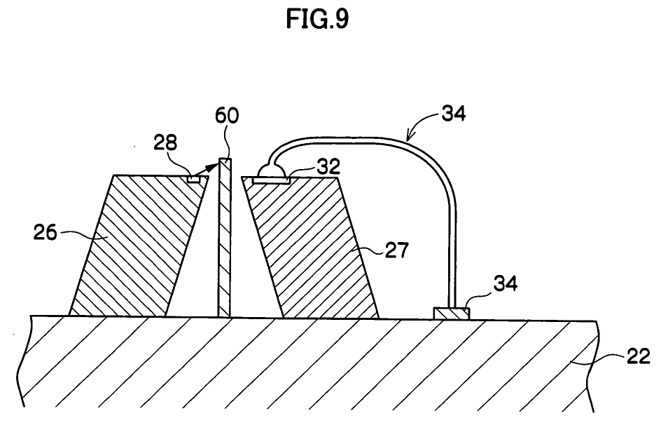

As shown in FIG. 9, the following structure may be employed: by disposing a light-blocking wall 60, which is formed of a silicon or epoxy material, between the LED arrays 26, 27 which are disposed adjacent to one another, the light-blocking wall 60 blocks the light from the light-emitting points of the LEDs 28 on the adjacent LED array 26, and the light does not reach the bonding wires 34.

Further, because it suffices for the light from the light-emitting points of the LEDs 28 on the adjacent LED array 26 to not reach the bonding wires 34, the present invention is not limited to the same, and the light-blocking wall may be provided in a vicinity of the first electrode pads 32 on the LED array 27.

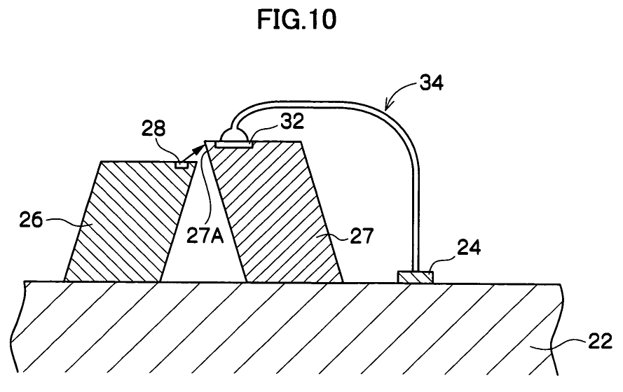

Further, the present invention is not limited to a light-blocking wall, and the following structure shown in FIG. 10 may be employed: by making the top surfaces of the LEDs 28 disposed at the adjacent LED array 26 lower than the top surfaces of the first electrode pads 32, the light from the light-emitting points of the LEDs 28 disposed at the adjacent LED array 26 is blocked by a side wall 27A of the LED array 27 at which the first electrode pads 32 are disposed. The light from the light-emitting points of these LEDs 28 does not reach the bonding wires 34.

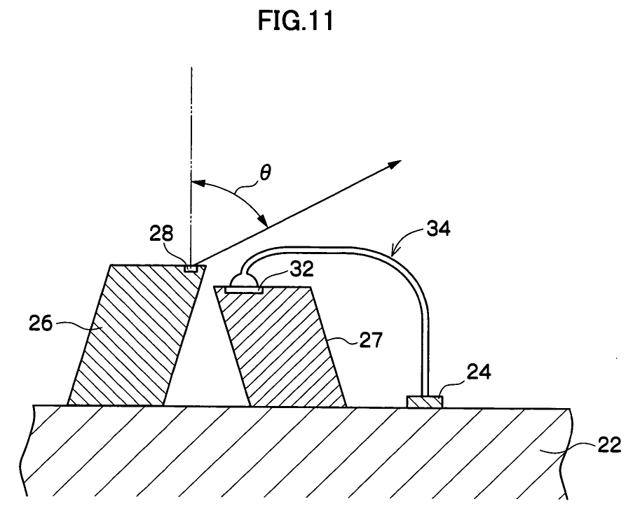

Further, the following structure shown in FIG. 11 may be employed: by making the top surfaces of the LEDs 28 disposed at the adjacent LED array 26 higher than the top surfaces of the first electrode pads 32, the bonding wires 34 are outside of the light-emitting region of these LEDs 28 (the region shown by the directional angle θ). The light from the light-emitting points of the LEDs 28 does not reach the bonding wires 34.

In addition, the first electrode pad 32 sides of the bonding wires 34 may be covered by the light-blocking insulators 50. In this case, not only is stray light due to the bonding wires 34 prevented, but also, the light-blocking insulators can be prevented from flowing toward the LEDs 28 at the time when the first electrode pads 32 are sealed by the light-blocking insulators.

Exemplary embodiments of the present invention are described above, but the present invention is not limited to the embodiment as will be clear to those skilled in the art. Namely, a first aspect of the present invention is an LED array head including: LED arrays at which plural LEDs are positioned; a substrate on which the LED arrays are staggered; first electrode pads provided at end portions of the LED arrays and positioned facing LEDs of adjacent LED arrays; second electrode pads provided on the substrate at a side opposite the adjacent LED arrays and connected to the first electrode pads electrically by wires; and light-blocking elements that block light, which is emitted from the LEDs of the adjacent LED arrays, from reaching the wires.

In the first aspect of the present invention, the first electrode pads are disposed at the end portions of the first LED arrays, and are disposed so as to oppose the LEDs disposed at the adjacent LED arrays. Further, the second electrode pads are disposed on the substrate at the side opposite the adjacent LED arrays, and are electrically connected to the first electrode pads by the wires.

Here, by providing the light-blocking elements which block the light, which is emitted from the LEDs of the adjacent LED arrays, from reaching the wires, the light from these LEDs is not reflected by the wires, and the occurrence of scattered light and stray light can be prevented.

Therefore, it suffices to not carry out stitch bonding at the first electrode pads as a countermeasure to stray light. Thus, the pad strength of the first electrode pads on the LED arrays can be made to be low, and the size of the first electrode pads can be made to be small.

Accordingly, because the LED chips are small and the number thereof which can be procured from one wafer is increased, the cost of the LED chip can be decreased. Moreover, because stray light is not generated even though the first electrode pads are small, compact LED arrays can be manufactured, and it is possible to make the image recording device more compact.

Further, because it suffices to not carry out stitch bonding at the first electrode pads as a countermeasure to stray light, the first run rate of production is improved. Namely, because the force of bonding to the first electrode pads can be made to be small, there is less damage such as cracking and the like to the LED arrays, and an improvement in the yield of the manufactured product can be anticipated.

In the above-described first aspect, the light-blocking elements may include light-blocking insulators covering first electrode pad sides of the wires.

In accordance with the above-described structure, the light from the light-emitting points of the LEDs disposed at the adjacent LED arrays is blocked by covering the first electrode pad sides of the wires by the light-blocking insulators. Thus, light is not reflected by the wires within the light-blocking insulators, and the occurrence of scattered light and stray light can be prevented. In this way, substantially the same effects as those of the above-described first aspect can be achieved.

In the above-described structure, at least surfaces of the light-blocking insulators may be a blackish color which does not substantially reflect the light from the LEDs.

Further, surfaces of the light-blocking insulators may be matte which does not substantially reflect the light from the LEDs.

Moreover, in the above-described first aspect, the light-blocking elements may include light-blocking walls provided between the first electrode pads and LEDs which are disposed facing to the first electrode pads.

In accordance with the above-described structure, by providing the light-blocking walls between the first electrode pads and the LEDs which are disposed facing to the first electrode pads, the light from the light-emitting points of the LEDs disposed at the adjacent LED arrays is blocked. Therefore, substantially the same effects as those of the above-described first aspect can be achieved.

In the above-described structure, the light-blocking walls may be provided in vicinities of the first electrode pads.

Further, the light-blocking walls may be disposed between the LED arrays which are adjacent each other.

Moreover, the top surfaces of the LEDs of the adjacent LED arrays and top surfaces of the first electrode pads may be different in heights so that light emitted from the LEDs of the adjacent LED arrays does not reach the wires.

In the above-described structure, due to the difference in heights between the top surfaces of the first electrode pads and the top surfaces of the LEDs disposed at the adjacent LED arrays, it is possible to make the light emitted from the light-emitting points of the LEDs disposed at the adjacent LED arrays not reach the wires. In this way, substantially the same effects as those of the first aspect of the present invention can be achieved.

In the above-described structure, the top surfaces of the LEDs disposed at the adjacent LED arrays may be higher than the top surfaces of the first electrode pads.

The top surfaces of the LEDs disposed at the adjacent LED arrays are made to be higher than the top surfaces of the first electrode pads. In this way, in addition to substantially the same effects as the first aspect of the present invention, the light-blocking insulators can be prevented from flowing toward the LEDs at the time when the first electrode pad portions are sealed by the light-blocking insulators.

In the above-described structure, the top surfaces of the LEDs disposed at the adjacent LED arrays may be lower than the top surfaces of the first electrode pads.

The top surfaces of the LEDs disposed at the adjacent LED arrays are made to be lower than the top surfaces of the first electrode pads. In this way, the light from the light-emitting points of the LEDs disposed at the adjacent LED arrays is blocked by the side wall of the LED array at which the first electrode pads are disposed, and substantially the same effects as the first aspect of the present invention can be achieved.

Moreover, the wires may be provided outside of light-emitting regions of the LEDs disposed at the adjacent LED arrays.

In accordance with this structure, by providing the wires to be outside of the light-emitting regions of the LEDs disposed at the adjacent LED arrays, the light from the light-emitting points of these LEDs does not reach the wires. In this way, substantially the same effects as those of the first aspect of the present invention can be achieved.

In the first aspect of the present invention, the wires may be provided by a low-loop bonding such as Bond Stitch on Ball or the like.

In the first aspect of the present invention, a dimension, in a short-side direction, of the LED arrays may be less than or equal to 130 μm. In accordance with this structure, by making the dimension, in the short-side direction, of the LED arrays be less than or equal to 130 μm (it is generally 300 μm), it is possible to make an image recording device more compact.

A second aspect of the present invention is an image recording device including an LED array head which includes: LED arrays at which plural LEDs are positioned; a substrate on which the LED arrays are staggered; first electrode pads provided at end portions of the LED arrays and positioned facing LEDs of adjacent LED arrays; second electrode pads provided on the substrate at a side opposite the adjacent LED arrays and connected to the first electrode pads electrically by wires; and light-blocking elements that block light, which is emitted from the LEDs of the adjacent LED arrays, from reaching the wires.

Because the present invention is structured as described above, the occurrence of scattered light and stray light can be prevented. Moreover, because it suffices to not carry out stitch bonding at the first electrode pads as a countermeasure to stray light, the pad strength of the first electrode pads on the LED arrays can be made to be low, and the size of the first electrode pads can be made to be small. Therefore, because the LED chips are small and the number thereof which can be procured from one wafer is increased, the cost of the LED chip can be decreased. In addition, because stray light is not generated even though the first electrode pads are small, compact LED arrays can be manufactured, and it is possible to make the image recording device more compact. Still further, because it suffices to not carry out stitch bonding at the first electrode pads as a countermeasure to stray light, the first run rate of production is improved. Namely, because the force of bonding to the first electrode pads can be made to be small, there is less damage such as cracking and the like to the LED arrays, and an improvement in the yield of the manufactured product can be anticipated.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to are suited to the particular use contemplated. It is intended that the scope of the invention be defined by the following claims and their equivalents.

What is claimed is:

1. An LED array head comprising:
LED arrays at which a plurality of LEDs are positioned;
a substrate on which the LED arrays are staggered;
first electrode pads provided at end portions of the LED arrays and positioned facing LEDs of adjacent LED arrays;
second electrode pads provided on the substrate at a side opposite the adjacent LED arrays and connected to the first electrode pads electrically by wires; and
light-blocking elements that block light, which is emitted from the LEDs of the adjacent LED arrays, from reaching the wires.

2. The LED array head of claim 1, wherein the light-blocking elements comprise light-blocking insulators covering first electrode pad sides of the wires.

3. The LED array head of claim 2, wherein at least surfaces of the light-blocking insulators have a blackish color which does not substantially reflect the light from the LEDs.

4. The LED array head of claim 2, wherein surfaces of the light-blocking insulators are matte which does not substantially reflect the light from the LEDs.

5. The LED array head of claim 1, wherein the light-blocking elements comprise light-blocking walls provided between the first electrode pads and the LEDs which face the first electrode pads.

6. The LED array head of claim 5, wherein the light-blocking walls are provided in vicinities of the first electrode pads.

7. The LED array head of claim 5, wherein the light-blocking walls are disposed between the LED arrays which are adjacent each other.

8. The LED array head of claim 1, wherein the wires are provided by a low-loop bonding.

9. The LED array head of claim 8, wherein the low-loop bonding is Bond Stitch on Ball.

10. The LED array head of claim 1, wherein a dimension, in a short-side direction, of the LED arrays is less than or equal to 130 μm.

11. An LED array head comprising:
LED arrays at which a plurality of LEDs are positioned;
a substrate on which the LED arrays are staggered;
first electrode pads provided at end portions of the LED arrays and positioned facing LEDs of adjacent LED arrays;
second electrode pads provided on the substrate at a side opposite the adjacent LED arrays and connected to the first electrode pads electrically by wires,
wherein the top surfaces of the LEDs of the adjacent LED arrays and top surfaces of the first electrode pads are different in heights so that light emitted from the LEDs of the adjacent LED arrays does not reach the wires.

12. The LED array head of claim 11, wherein the top surfaces of the LEDs of the adjacent LED arrays are higher than the top surfaces of the first electrode pads.

13. The LED array head of claim 11, wherein the top surfaces of the LEDs of the adjacent LED arrays are lower than the top surfaces of the first electrode pads.

14. The LED array head of claim 11, wherein the wires are provided by a low-loop bonding.

15. The LED array head of claim 14, wherein the low-loop bonding is Bond Stitch on Ball.

16. The LED array head of claim 11, wherein a dimension, in a short-side direction, of the LED arrays is less than or equal to 130 μm.

17. An LED array head comprising:
LED arrays at which a plurality of LEDs are positioned;
a substrate on which the LED arrays are staggered;
first electrode pads provided at end portions of the LED arrays and positioned facing LEDs of adjacent LED arrays;
second electrode pads provided on the substrate at a side opposite the adjacent LED arrays and connected to the first electrode pads electrically by wires,
wherein the wires are provided outside of light-emitting regions of the LEDs of the adjacent LED arrays.

18. The LED array head of claim 17, wherein the wires are provided by a low-loop bonding.

19. The LED array head of claim 18, wherein the low-loop bonding is Bond Stitch on Ball.

20. The LED array head of claim 17, wherein a dimension, in a short-side direction, of the LED arrays is less than or equal to 130 μm.

21. An image recording device comprising an LED array head, the LED array head comprising:
LED arrays at which a plurality of LEDs are positioned;
a substrate on which the LED arrays are staggered;
first electrode pads provided at end portions of the LED arrays and positioned facing LEDs of adjacent LED arrays;
second electrode pads provided on the substrate at a side opposite the adjacent LED arrays and connected to the first electrode pads electrically by wires; and
light-blocking elements that block light, which is emitted from the LEDs of the adjacent LED arrays, from reaching the wires.

22. An image recording device comprising an LED array head, the LED array head comprising:
LED arrays at which a plurality of LEDs are positioned;
a substrate on which the LED arrays are staggered;
first electrode pads provided at end portions of the LED arrays and positioned facing LEDs of adjacent LED arrays;
second electrode pads provided on the substrate at a side opposite the adjacent LED arrays and connected to the first electrode pads electrically by wires,
wherein the wires are provided outside of light-emitting regions of the LEDs of the adjacent LED arrays.
